(19) United States
(12) Patent Application Publication
(10) Pub. No.: US 2009/0154431 A1
(43) Pub. Date: Jun. 18, 2009

(54) MEDIUM ACCESS CONTROL FOR XOR-ED PACKETS

(75) Inventors: Kevin Tang, Dublin, CA (US); Cedric Westphal, San Francisco, CA (US); Meghana Sahasrabudhe, Sunnyvale, CA (US); Yinghua Ye, Mountain View, CA (US)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy

(21) Appl. No.: 11/956,076

(22) Filed: Dec. 13, 2007

(51) Int. Cl. H04Q 7/24

(52) U.S. Cl. 370/338

(57) ABSTRACT

Various example embodiment are disclosed. An example embodiment may include sending, by a relay node in a wireless network, a ready to send message to a plurality of wireless nodes. The ready to send message may indicate access channels for each of the wireless nodes to send clear to send messages. This example may also include receiving, via the indicated access channels for sending the clear to send messages, the clear to send messages from each of the wireless nodes. This example may also include sending an XOR-ed packet to the wireless nodes in response to receiving the clear to send messages. The XOR-ed packet may indicate access channels for each of the wireless nodes to send acknowledgment messages. An example may also include receiving, via the indicated access channels for sending the acknowledgment messages, the acknowledgment messages from each of the wireless nodes

### TECHNICAL FIELD

This description relates to wireless networks.

### BACKGROUND

Wireless networks may include a plurality of wireless nodes. In star networks or partial mesh networks, for example, some wireless nodes may be out of range of each other, and may have packets forwarded to each other by, for example, relay nodes.

### SUMMARY

According to one general aspect, a method may include sending, by a relay node in a wireless network, a ready to send message to a plurality of wireless nodes. The ready to send message may indicate access channels for each of the wireless nodes to send clear to send messages. The method may also include receiving, via the indicated access channels for sending the clear to send messages, the clear to send messages from each of the wireless nodes. The method may also include sending an XOR-ed packet to the wireless nodes in response to receiving the clear to send messages.

According to another general aspect, a method may include receiving, by a wireless node in a wireless network, a ready to send message from a relay node. The ready to send message may indicate an access channel to send a clear to send message. The method may further include sending, to the relay node, the clear to send message via the access channel indicated for the clear to send message. The method may further include receiving an XOR-ed packet from the relay node. The method may further include decoding the XOR-ed packet by XOR-ing the XOR-ed packet with a native packet stored in a packet pool of the wireless node.

According to another general aspect, an apparatus may include a memory, a controller, and a wireless transceiver. The memory may be configured to store queued packets in an output queue and a packet pool for each of a plurality of wireless nodes. The controller may be configured to select at least two of the queued packets based on the sets of native packets and generate an XOR-ed packet by XOR-ing at least two of the selected queued packets. The a wireless transceiver may be configured to send a ready to send message to a plurality of wireless nodes, the ready to send message indicating access channels for each of the wireless nodes to send clear to send messages, to receive, via the indicated access channels for sending the clear to send messages, the clear to send messages from each of the wireless nodes, and to send the XOR-ed packet to the wireless nodes in response to receiving the clear to send messages.

According to another general aspect, an apparatus may include a memory, a controller, and a wireless transceiver. The memory may be configured to store native packets in a packet pool. The wireless transceiver may configured to receive a ready to send message from a relay node, the ready to send message indicating an access channel to send a clear to send message, to send the clear to send message to the relay node via the access channel indicated for the clear to send message, and to receive an XOR-ed packet from the relay node. The controller may be configured to decode the XOR-ed packet by XOR-ing the XOR-ed packet with at least one of the native packets stored in the packet pool.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram showing a wireless network according to an example embodiment.

FIG. 2 is a vertical-time sequence diagram showing messages sent between a relay node and two wireless nodes according to an example embodiment.

FIG. 3A is a block diagram showing an IEEE 802.11 packet according to an example embodiment.

FIG. 3B is a block diagram showing a ready to send header according to an example embodiment.

FIG. 3C is a block diagram showing a clear to send header according to an example embodiment.

FIG. 3D is a block diagram showing an XOR-ed packet header according to an example embodiment.

FIG. 3E is a block diagram showing an acknowledgment message header according to an example embodiment.

FIG. 4 is a flowchart showing a method according to an example embodiment.

FIG. 5 is a flowchart showing a method according to another example embodiment.

FIG. 6 is a block diagram showing an apparatus according to an example embodiment.

### DETAILED DESCRIPTION

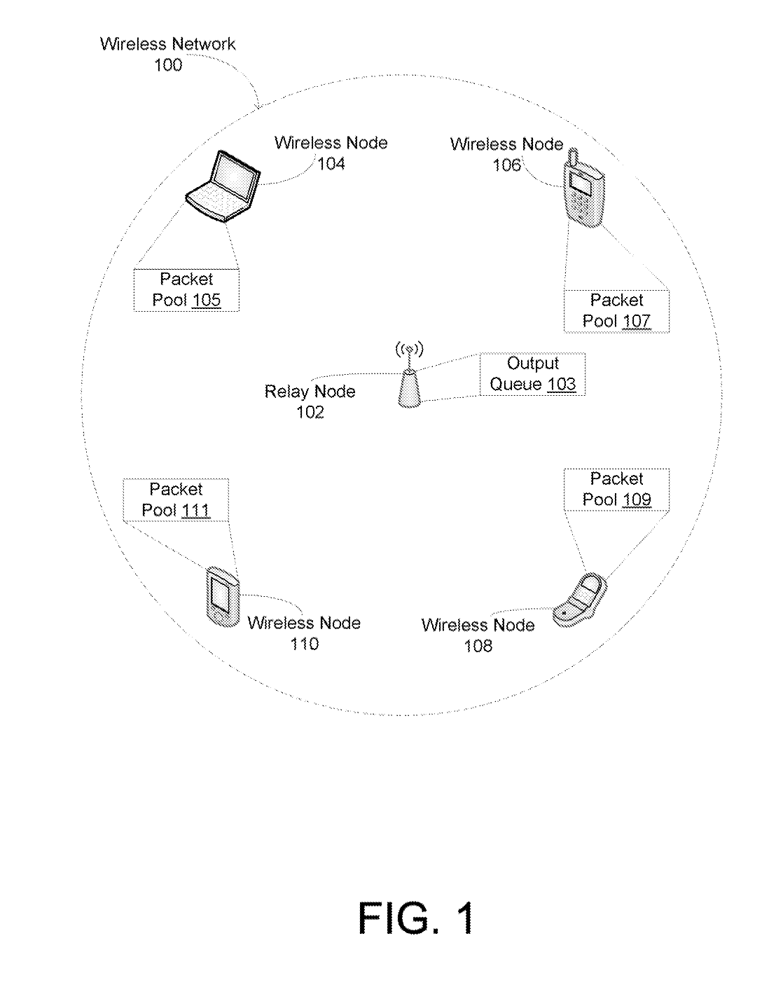

FIG. 1 is a diagram showing a wireless network 100 according to an example embodiment. The wireless network 100 may include, for example, an 802.11 WLAN network, IEEE 802.16 WiMax network, or a cellular telephone network. The wireless network 100 may include a number of nodes 102, 104, 106, 108, 110.

The nodes 102, 104, 106, 108, 110 may include a relay node 102 and a plurality of wireless nodes 104, 106, 108, 110. While one relay node 102 and a four wireless nodes 104, 106, 108, 110 are shown in FIG. 1, any number of relay nodes 102 and wireless nodes 104, 106, 108, 110 may be included. The relay node 102 may include an 802.11 access point, a gateway, node-B, or a cellular base station, according to various example embodiments. The wireless nodes 104, 106, 108, 110 may include, for example, laptop or notebook computers, smartphones, cellular telephones, and/or personal digital assistants (PDAs), according to example embodiments.

The wireless network 100 may include, for example, a star topology in which the relay node 102 communicates with the plurality of wireless nodes 104, 106, 108, 110. In this example, the wireless nodes 104, 106, 108, 110 may not communicate with each other directly, and send packets destined to other wireless nodes 104, 106, 108, 110 to the relay node 102, which forwards the packets to the destined wireless nodes 104, 106, 108, 110.

The wireless network 100 may also include, for example, a partial mesh topology in which each node 102, 104, 106, 108, 110 may communicate with one or more other nodes 102, 104, 106, 108, 110, but not all nodes 102, 104, 106, 108, 110 are able to communicate with all of the other nodes 102, 104, 106, 108, 110. For example, the wireless node 104 may be able to communicate with the relay node 102, the wireless node 106, and the wireless node 110, but not with the wireless node 108. Similarly, the wireless node 106 may be able to communicate with the relay node 102, the wireless node 104, and the wireless node 108, but not the wireless node 110; the wireless node 108 may be able to communicate with the relay node 102, the wireless node 106, and the wireless node 110, but not with the wireless node 104; and the wireless node 110 may be able to communicate with the relay node 102, the wireless node 104, and the wireless node 108, but not the wireless node 106. While the example in FIG. 1 shows one relay node 102 which may relay and/or forward packets sent by the wireless nodes 104, 106, 108, 110, in other examples, the wireless nodes 104, 106, 108, 110 may relay and/or forward packets to or from the wireless nodes 104, 106, 108, 110 and to or from other wireless nodes not shown in FIG. 1.

According to an example embodiment, the relay node 102 may XOR two or more packets and send or forward them as a single transmission, rather than sending each of the two or more packets as separate transmissions. In the example shown in FIG. 1, the relay node 102 may store queued packets in an output queue 103. The output queue 103 may include queued packets received by the relay node 102 from the wireless nodes 104, 106, 108, 110 which are to be sent or forwarded by the relay node 102 to any or all of the wireless nodes 104, 106, 108, 110. The output queue 103 may also include destination addresses indicating which wireless node(s) 104, 106, 108, 110 each of the queued packets are destined for.

The wireless nodes 104, 106, 108, 110 may store native or non-encoded packets in respective packet pools 105, 107, 109, 111. The wireless nodes 104, 106, 108, 110 may, for example, store native packets which were sent and/or received within a certain time period. The relay node 102 may determine sets of native packets for each of the wireless nodes 104, 106, 108, 110. For example, in a star and/or mesh topology, the relay node 102 may determine that native packets sent by a wireless node 104, 106, 108, 110 are in that wireless node's 104, 106, 108, 110 set of native packets or packet pool. In a mesh or partial mesh topology, the relay node 102 may also determine that packets sent by a neighboring wireless node 104, 106, 108, 110 are in that wireless node's 104, 106, 108, 110 set of native packets or packet pool. For example, the relay node 102 may determine that packets sent by the wireless node 106 and/or wireless node 110 are in the wireless node's 104 set of native packets or packet pool, but that packets sent by the wireless node 108 are not in the wireless node's 104 set of native packets or packet pool.

In an example embodiment, the relay node 102 may XOR a packet destined for a particular wireless node 104, 106, 108, 110 with another packet that is already stored in that wireless node's 104, 106, 108, 110 packet pool 105, 107, 109, 111. For example, wireless node 104 may send packet A, which is destined for wireless node 108, to the relay node 102, and store packet A in its packet pool 105. The relay node 102 may store packet A in its output queue 103 and determine that packet A is included in wireless node 104's set of native packets. Wireless node 108 may send packet B, which is destined for wireless node 104, to the relay node 102, and store packet B in its packet pool 109. The relay node 102 may store packet B in its output queue 103 and determine that packet B is included in wireless node 108's set of native packets. The relay node 102 may XOR packet A and packet B, and send the XOR-ed packet to both wireless nodes 104, 108. Wireless node 104 may decode the XOR-ed packet by XOR-ing the XOR-ed packet with native packet A stored in the packet pool 105 to generate packet B, and wireless node 108 may decode the XOR-ed packet by XOR-ing the XOR-ed packet with native packet B stored in the packet pool 109 to generate packet A.

In an example using a partial mesh topology, wireless node 104 may send packet A, which is destined for wireless node 108, to the relay node 102. Wireless node 104 may store packet A in its packet pool 105; wireless nodes 106 and 110 may also receive the packet A and store packet A in their respective packet pools 107, 111. Similarly, wireless node 106 may send packet B, destined for wireless node 110, to the relay node 102, and wireless nodes 104, 106, 108 may store packet B in their respective packet pools 105, 107, 109; wireless node 108 may send packet C, destined for node 104, to the relay node 102, and wireless nodes 106, 108, 110 may store packet C in their respective packet pools 107, 109, 111; and wireless node 110 may send packet D, destined for wireless node 106, to the relay node 102, and wireless nodes 104, 108, 110 may store packet D in their respective packet pools 105, 109, 111.

The relay node 102 may store packets A, B, C, D in its output queue 103, and may generate an XOR-ed packet by XOR-ing packets A, B, C, D. The relay node 102 may send the XOR-ed packet to the wireless nodes 104, 106, 108, 110. The wireless nodes 104, 106, 108, 110 may decode the XOR-ed packet by XOR-ing the XOR-ed packet with one or more native packets stored in their respective packet pools 105, 107, 109, 111. For example, the wireless node 104 may decode the XOR-ed packet by XOR-ing the XOR-ed packet with packets A, B, and D to generate packet C; wireless node 106 may decode the XOR-ed packet by XOR-ing the XOR-ed packet with packets A, B, and C to generate packet D; wireless node 108 may decode the XOR-ed packet by XOR-ing the XOR-ed packet with packets B, C, and D to generate packet A; and the wireless node 110 may decode the XOR-ed packet by XOR-ing the XOR-ed packet with packets A, C, and D to generate packet B.

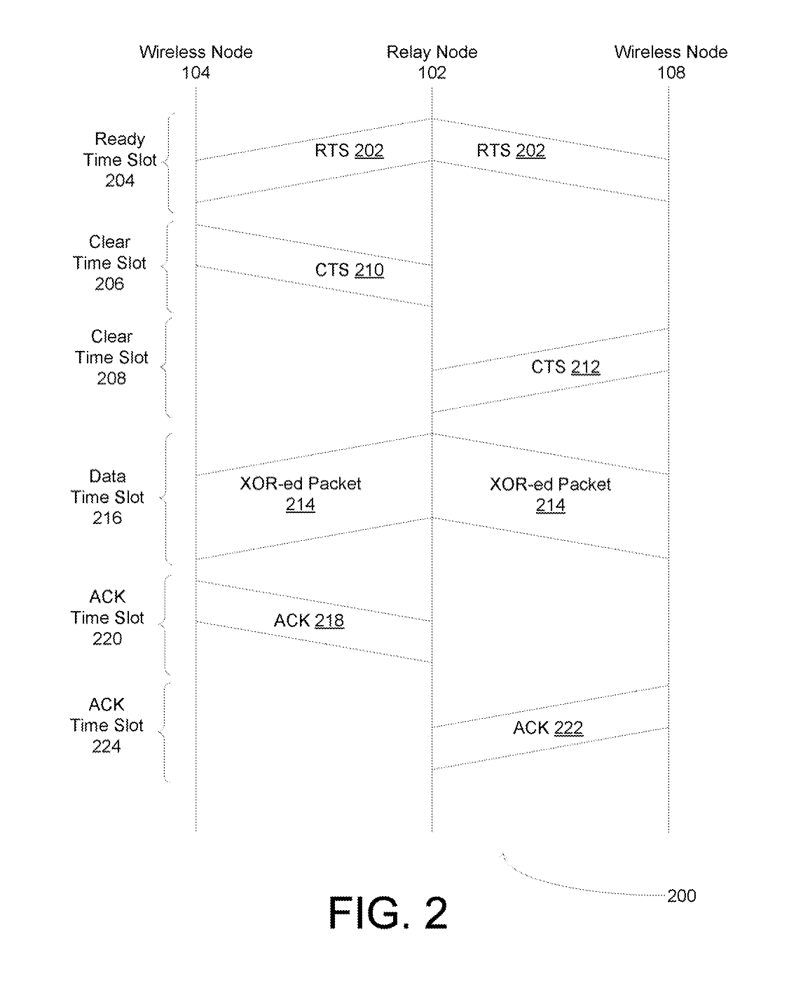

FIG. 2 is a vertical-time sequence diagram 200 showing messages sent between the relay node 102 and two wireless nodes 104, 108 according to an example embodiment. In this example, the nodes 102, 104, 108 may send medium access control messages to ensure that the wireless channel is available for sending the XOR-ed packet. For example, the relay node 102 may send a ready to send message 202 to a plurality of wireless node, such as the wireless nodes 104, 108. The relay node 102 may send the ready to send message 202 to wireless nodes 104, 106, 108, 110 for which the relay node 102 has queued packets stored in its packet queue. The ready to send message 202 may be sent to the wireless nodes 104, 108 via a particular access channel; in the example shown in FIG. 2, relay node 102 sends the ready to send message 204 to the wireless nodes 104, 108 during a ready time slot 204.

The ready to send message 202 may indicate access channels for each of the wireless nodes 104, 108 to send clear to send message. The relay node 102 may thereby assign separate access channels via which each of the wireless nodes 104, 108 may send clear to send messages to the relay node 102. In the example shown in FIG. 2, the ready to send message 202 may indicate time slots for the wireless nodes 104, 108 to send the clear to send messages to the relay node 102. For example, the relay node 102 may assign time slot 206 to the wireless node 104 and time slot 208 to the wireless node 108. While the relay node 102 assigns time slots 206, 208 to the wireless nodes 104, 108 in the example shown in FIG. 2, in other examples the relay node 102 may assign frequency channels or code-division multiple access (CDMA) codes to the wireless nodes 104, 108.

In response to receiving the ready to send message 202 from the relay node 102, the wireless nodes 104, 108 may send clear to send messages 210, 212 to the relay node 102 via the indicated access channel. For example, the wireless node 104 may send the clear to send message 210 to the relay node 102 during the clear time slot 206, and the wireless node 108 may send the clear to send message 212 to the relay node 102 during the clear time slot 208. The wireless nodes 104, 108 may send the clear to send messages 210, 212 to the relay node 102 in response to receiving the ready to send message 202 based, for example, on determining that the wireless channel is clear and that the wireless node 104, 108 will not send a packet while the relay node 104 is sending data to the wireless node.

In response to receiving the clear to send messages 210, 212 from the wireless nodes 104, 108, the relay node 102 may send an XOR-ed packet 214 to the wireless nodes 104, 108. The XOR-ed packet 214 may be generated as described above with reference to FIG. 1, according to an example embodiment. The relay node 102 may send the XOR-ed packet 214 to the wireless nodes 104, 108 via an access channel indicated by the ready to send message 202, according to an example embodiment. In the example shown in FIG. 2, the relay node 102 sends the XOR-ed packet 214 to the wireless nodes 104, 108 during a data time slot 216 indicated by the ready to send message 202. The XOR-ed packet 214 may indicate access channels via which the wireless nodes 104, 108 may send acknowledgment messages, according to an example embodiment.

The relay node 102 may generate the XOR-ed packet 214 based on which wireless nodes 104, 106, 108, 110 sent clear to send messages 210, 212 to the relay node. If only one wireless node 104, 106, 108, 110 sent a clear to send message 210, 212 to the relay node 102, then the relay node 102 may send a native packet without XOR-ing to the wireless node 104, 106, 108, 110 which sent the clear to send message 210, 212.

The wireless nodes 104, 108, in response to receiving the XOR-ed packet 214, may decode the XOR-ed 214 packet by XOR-ing the XOR-ed packet 214 with at least one native packet stored in their respective packet pools 105, 109, as described above with reference to FIG. 1. In an example embodiment, the wireless nodes 104, 108 may also, in response to receiving the XOR-ed packet 214, send acknowledgment messages to the relay node 102. In response to receiving the acknowledgment messages, the relay node 102 may remove the acknowledged queued messages from its output queue 103.

The wireless nodes 104, 108 may send the acknowledgment messages to the relay node 102 via the access channels indicated by the XOR-ed packet 214. In the example shown in FIG. 2, the wireless node 104 may send an acknowledgment message 218 to the relay node 102 during an acknowledgment time slot 220, and the wireless node 108 may send an acknowledgment message 222 to the relay node during an acknowledgment time slot 224. In an example embodiment, the relay node 102 may resend the XOR-ed packet 214 if the relay node 102 does not receive acknowledgment messages 218, 222 from all the wireless nodes 104, 108 from which the relay node 102 receives clear to send messages 210, 212 within a timeout period. Or, if the relay node 102 receives an acknowledgment message 218, 222 from at least one but less than all of the wireless nodes 104, 108 for which the XOR-ed packet 214 was intended, the relay node 102 may send a native packet for the wireless node 104, 108, or may remove the queued messages and may send a new XOR-ed packet, and/or may repeat the process of sending the ready to send message 202 and receiving the clear to send messages 210, 212, if node 102 receives all the acknowledgment messages 218, 222. In another example embodiment, the relay node 102 may remove the queued messages from its output queue 103 unless the relay node 102 receives negative acknowledgment messages (not shown) within a timeout period, and may resend the queued packets in response to receiving negative acknowledgment messages.

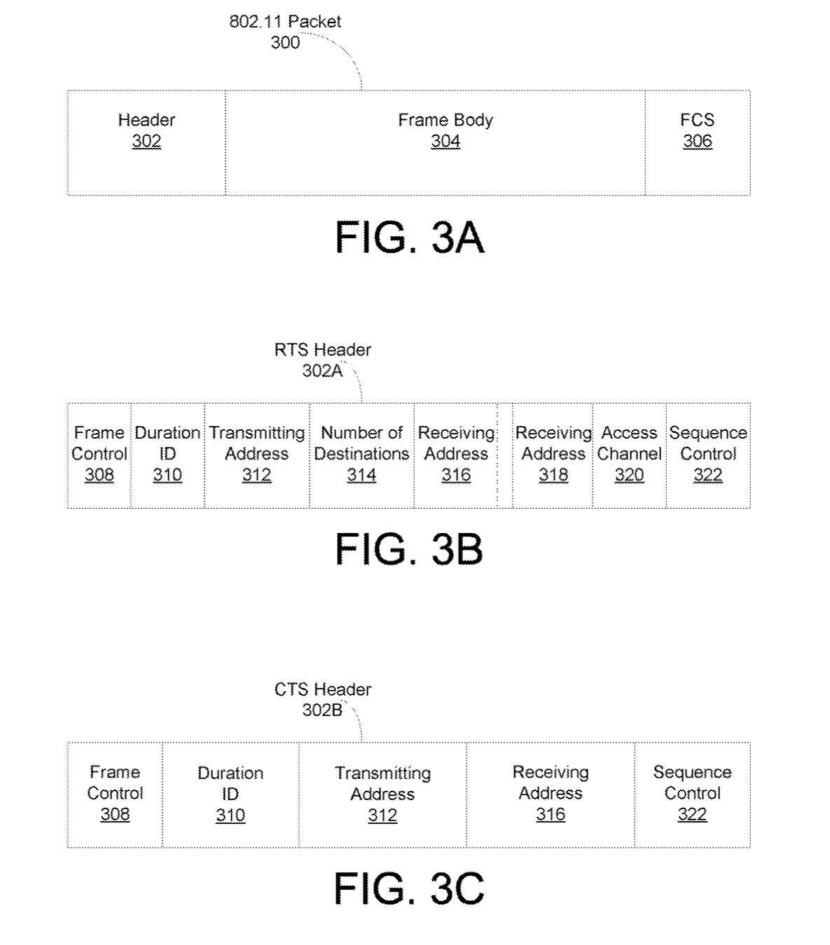

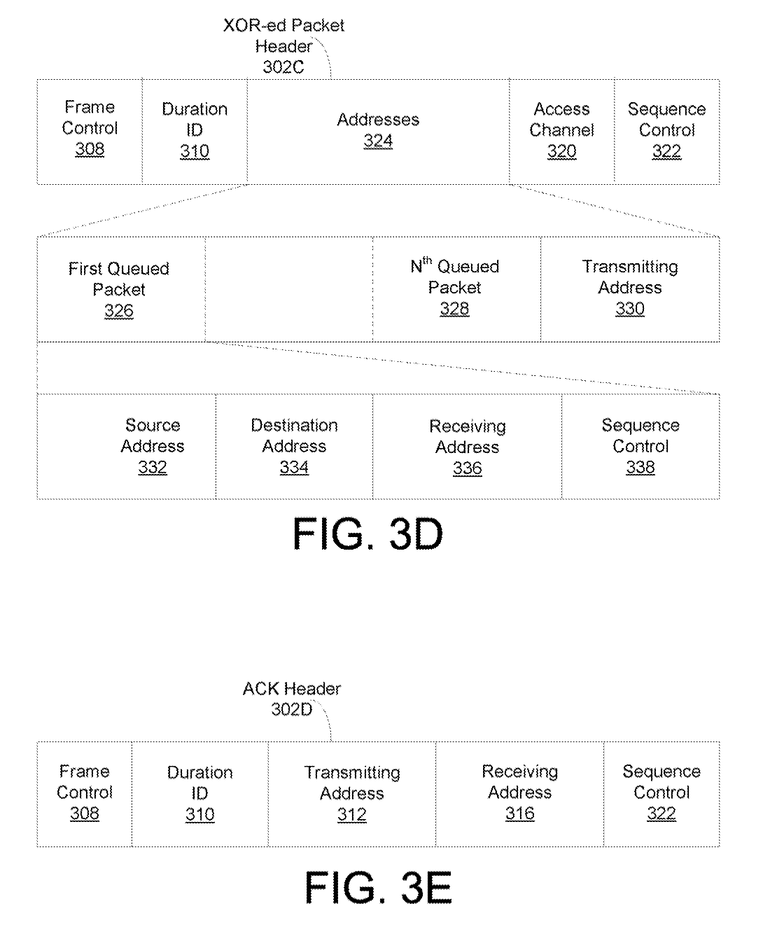

FIG. 3A is a block diagram showing an IEEE 802.11 packet 300 according to an example embodiment. The 802.11 packet 300 may be sent or received by any of the nodes 102, 104, 106, 108, 110. While FIG. 3A shows an 802.11 packet 300, other types of packets may be sent or received in other examples. The ready to send message 202, clear to send messages 210, 212, XOR-ed packet 214, acknowledgment messages 218, 222, and/or native packets (not shown) may be of the 802.11 packet 300 format shown in FIG. 3A, according to an example embodiment.

The 802.11 packet 300 may include a header field 302. The header field 302 may be of various formats, depending on the type of packet. Four example formats for the header are shown in FIGS. 3B, 3C, 3D, and 3E.

The 802.11 packet 300 may also include a frame body field 304. The frame body field 304 may include the data or payload included in the 802.11 packet 300, according to an example embodiment. In the example in which the 802.11 packet 300 includes an XOR-ed packet 214, the frame body may include a XOR-ed total of the queued packets based upon which the XOR-ed packet 214 was generated.

The 802.11 packet 300 may also include a frame check sequence field 306. The frame check sequence field 306 may include error detection information, such as a frame check sequence.

FIG. 3B is a block diagram showing a ready to send header 302A according to an example embodiment. The ready to send header 302A may be included in a ready to send message 202, according to an example embodiment. The ready to send header 302A may include a frame control field 308 which identifies the ready to send message 202, which may include an 802.11 packet, as a ready to send message. The ready to send header 302A may also include a duration ID field 310 and/or a transmitting address field 312 indicating an identity of the relay node 102. The ready to send header 302A may also include a number of destinations field 314 indicating a number of wireless nodes 104, 108 to which the ready to send message 202 is being sent, which may also indicate a number of wireless nodes 104, 108 to which the XOR-ed packet 214 will be sent. The ready to send header 302A may also include a receiving address field 316, 318 indicating an address which identifies each of the wireless nodes 104, 108 to which the ready to send message 202 is being sent. The ready to send header 302A may also include an access channel field 320 indicating access channels via which the wireless nodes 104, 108 should send the clear to send messages 210, 212, such as the clear time slots 206, 108. Alternatively, the access channels may be implied by the order of the receiving addresses within the clear to send header 302A. The ready to send header 302A may also include a sequence control field 322 which may indicate a sequence number for the ready to send message 202.

FIG. 3C is a block diagram showing a clear to send header 302B according to an example embodiment. The clear to send header 302B may be included in a clear to send message 210, 212, according to an example embodiment. The clear to send header 302B may include a frame control field 308 which identifies the clear to send message 210, 212, which may include an 802.11 packet, as a clear to send message. The clear to send header 302B may also include a duration ID field 310 and/or a transmitting address field 312 indicating an identity of the wireless node 104, 106, 108, 110. The clear to send header 302B may also include a receiving address field 316 identifying the relay node 102 or other wireless node 104, 106, 108, 110 to which the clear to send message 210, 212 is being sent. The clear to send header 302B may also include a sequence control field 322 which may indicate a sequence number for the clear to send message 210, 212.

FIG. 3D is a block diagram showing an XOR-ed packet header 302C according to an example embodiment. The XOR-ed packet header 302C may be included in an XOR-ed packet 214. The XOR-ed packet header 302C may include a frame control field 308 identifying the XOR-ed packet 214 as an XOR-ed packet. The XOR-ed packet header 302C may also include a duration ID field 310 indicating a length of the XOR-ed packet 214. The XOR-ed packet header 302C may also include an addresses field 324, described in the following paragraph. The XOR-ed packet header 302C may also include an access channel field 320, which may indicate access channels, such as acknowledgment time slots 220, 224, via which the wireless nodes 104, 106, 108, 110 may send acknowledgment messages 218, 222. The access channels may also be implied by the order of the addresses included in the addresses field 324. The XOR-ed packet header 302C may also include a sequence control field 322 indicating a sequence number of the XOR-ed packet 214.

The addresses field 324 may include a queued packet subfield 326, 328 for each of the queued packets which are XOR-ed in the XOR-ed packet 214. Each of the queued packet subfields 326, 328 may include four subfields described in the following paragraph. The addresses field 324 may also include a transmitting address subfield 330 identifying the address of the relay node 102.

Each queued packet subfield 326, 328 may include a source address subfield 332, a destination address subfield 334, a receiving address subfield 336, and a sequence control subfield 338. The source address subfield 332 may indicate an address of the node 102, 104, 106, 108, 110 which originally sent the queued packet stored in the output queue 103. The destination address subfield 334 may indicate an address of the node 102, 104, 106, 108, 110 which is the final destination of the queued packet. The receiving address subfield 336 may indicate an address of the node 102, 104, 106, 108, 110 which is receiving the XOR-ed packet 214 and will decode the XOR-ed packet 214 to generate the queued packet. The sequence control subfield 338 may indicate a sequence number of the queued packet.

FIG. 3E is a block diagram showing an acknowledgment message header 302D according to an example embodiment. The acknowledgment message header 302D may be included in an acknowledgment message 218, 222, according to an example embodiment. The acknowledgment message header 302D may include a frame control field 308 which identifies the acknowledgment message 218, 222, which may include an 802.11 packet, as an acknowledgment message. The acknowledgment message header 302D may also include a duration ID field 310 and/or a transmitting address field 312 indicating an identity of the wireless node 104, 106, 108, 110. The acknowledgment message header 302D may also include a receiving address field 316 identifying the relay node 102 or other wireless node 104, 106, 108, 110 to which the acknowledgment message 218, 222 is being sent. The acknowledgment message header 302E may also include a sequence control field 322 which may indicate a sequence number for the acknowledgment message 218, 222.

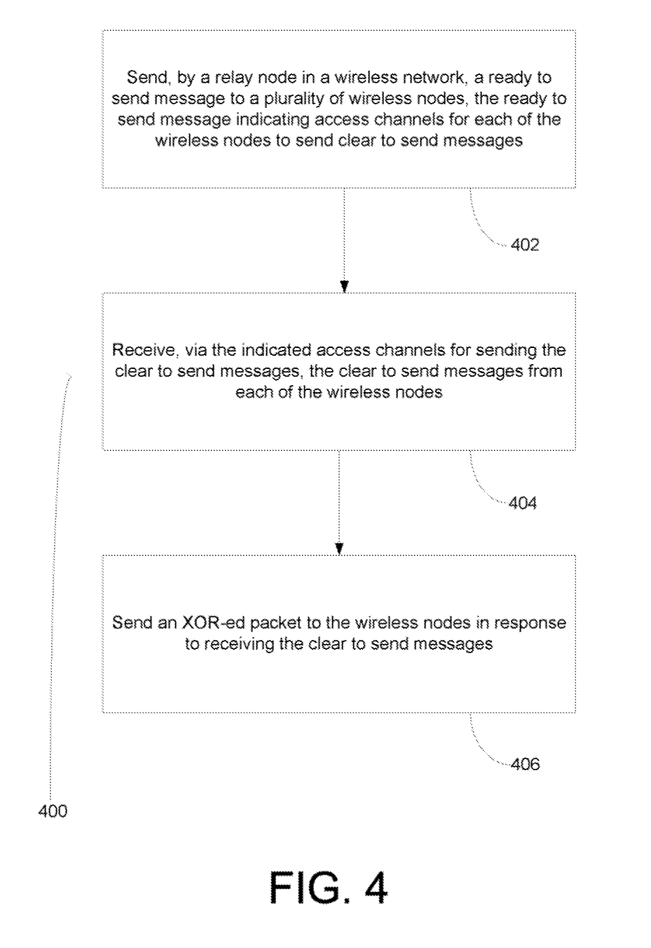

FIG. 4 is a flowchart showing a method 400 according to an example embodiment. According to this example, the method 400 may include sending, by a relay node 102 in a wireless network 100, a ready to send message 202 to a plurality of wireless nodes 104, 106, 108, 110, the ready to send message 202 indicating access channels for each of the wireless nodes 104, 106, 108, 110 to send clear to send messages 210, 212 (402). The method 400 may further include receiving, via the indicated access channels for sending the clear to send messages, the clear to send messages 210, 212 from each of the wireless nodes 104, 106, 108, 110 (404). The method 400 may further include sending an XOR-ed packet 214 to the wireless nodes 104, 106, 108, 110 in response to receiving the clear to send messages 210, 212 (406).

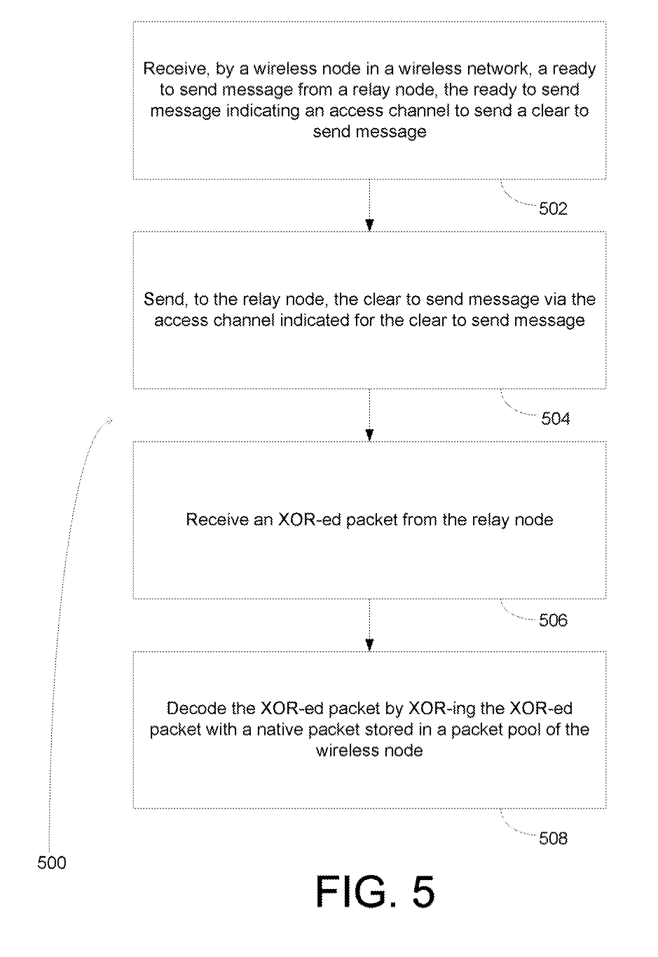

FIG. 5 is a flowchart showing a method 500 according to another example embodiment. In this example, the method 500 may include receiving, by a wireless node 104, 106, 108, 110 in a wireless network 100, a ready to send message 202 from a relay node 102, the ready to send message 202 indicating an access channel to send a clear to send message 210, 212 (502). The method 500 may also include sending, to the relay node 102, the clear to send message 210, 212 via the access channel indicated for the clear to send message (504). The method 500 may also include receiving an XOR-ed packet 214 from the relay node 102 (506). The method 500 may also include decoding the XOR-ed packet by XOR-ing the XOR-ed packet 214 with a native packet stored in a packet pool 105, 107, 109, 111 of the wireless node 104, 106, 108, 110 (508).

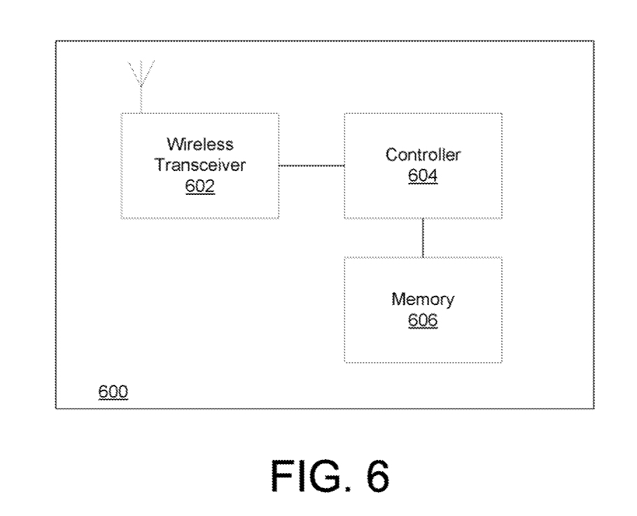

FIG. 6 is a block diagram showing an apparatus 600 according to an example embodiment. The apparatus 600 may include a relay node 102 or a wireless node 104, 106, 108, 110, according to example embodiments. The apparatus 600 may include, for example, a wireless transceiver 602, a controller 604, and a memory 606.

In an example in which the apparatus 600 includes a relay node 102, the memory 606 may be configured to store queued packets in the output queue 103 and to store, for each of a plurality of wireless nodes 104, 106, 108, a set of native packets or a packet pool.

The controller 604 may be configured to select at least two of the queued packets based on the sets of native packets or packet pools. The controller 604 may be further configured to generate an XOR-ed packet 214 by XOR-ing at least two of the selected queued packets. The controller 604 may be further configured to add native packets to the sets of native packets or packet pools based on receiving packets from the wireless nodes 104, 106, 108, 110. The controller 604 may be further configured to add native packets to the sets of native packets or packet pools based on packet pool fields included in the clear to send messages 210, 212.

The wireless transceiver 602 may be configured to send a ready to send message 202 to a plurality of wireless nodes 104, 106, 108, 110. The ready to send message 202 may indicate access channels for each of the wireless nodes 104, 106, 108, 110 to send clear to send messages 210, 212. The wireless transceiver 602 may be further configured to receive, via the indicated access channels for sending the clear to send messages, the clear to send messages 210, 212 from each of the wireless nodes 104, 106, 108, 110. The wireless transceiver 602 may be further configured to send the XOR-ed packet 214 to the wireless nodes 104, 106, 108, 110 in response to receiving the clear to send messages 210, 212. The wireless transceiver 602 may be further configured to receive, via the indicated access channels for sending the acknowledgment messages, the acknowledgment messages 218, 222 from each of the wireless nodes 104, 106, 108, 110. The controller 604 may be further configured to process acknowledgment messages.

In an example in which the apparatus 600 includes a wireless node 104, 106, 108, 110, the memory 606 may be configured to store native packets in a packet pool 105, 107, 109, 111. The wireless transceiver 602 may be configured to receive a ready to send message 202 from the relay node 102. The ready to send message 202 may indicate an access channel to send a clear to send message 210, 212. The wireless transceiver 602 may be further configured to send the clear to send message 210, 212 to the relay node 102 via the access channel indicated for the clear to send message 210, 212. The wireless transceiver 602 may be further configured to receive a XOR-ed packet 214 from the relay node 102. The controller 604 may be configured to decode the XOR-ed packet 214 by XOR-ing the XOR-ed packet 214 with at least one of the native packets stored in the packet pool 105, 107, 109, 111. The wireless transceiver 602 may be further configured to send the acknowledgment message 218, 222 to the relay node 102 via the access channel indicated for the acknowledgment message 218, 222.

In an example embodiment, the wireless transceiver 602 may be configured to send the clear to send message 210, 212 to the relay node 102 during a time slot 206, 208 indicated by the ready to send message 202. In another example embodiment, the wireless transceiver 602 may be configured to send a packet to the relay node 102, and the controller 604 may be configured to add the packet to the packet pool 405, 407, 409, 411 as a native packet based on the wireless transceiver 602 sending the packet. In another example embodiment, the wireless transceiver 602 may be configured to receive a packet from a neighboring wireless node 104, 106, 108, 110, and the controller 604 may be configured to add the packet to the packet pool 405, 407, 409, 411 as a native packet based on the wireless transceiver 602 receiving the packet.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
sending, by a relay node in a wireless network, a ready to send message to a plurality of wireless nodes, the ready to send message indicating access channels for each of the wireless nodes to send clear to send messages;
receiving, via the indicated access channels for sending the clear to send messages, the clear to send messages from each of the wireless nodes; and
sending an XOR-ed packet to the wireless nodes in response to receiving the clear to send messages.

2. The method of claim 1 wherein the sending the ready to send message includes sending, by the relay node in the wireless network, the ready to send message to the plurality of wireless nodes, the ready to send message indicating the access channels for each of the wireless nodes to send the clear to send messages, the access channels including time slots.

3. The method of claim 1 wherein the sending the ready to send message includes sending, by the relay node in the wireless network, the ready to send message to the plurality of wireless nodes, the ready to send message including an access channel field which indicates the access channels for each of the wireless channels to send the clear to send messages.

4. The method of claim 1 wherein the sending the ready to send message includes sending, by the relay node in the wireless network, the ready to send message to the plurality of wireless nodes, the ready to send message including a frame control field identifying the ready to send message as a ready to send message.

5. The method of claim 1 wherein the receiving includes receiving, via the indicated access channels for sending the clear to send messages, the clear to send messages from each of the wireless nodes, the clear to send messages indicating native packets in each of the wireless nodes' packet pools.

6. The method of claim 1 wherein the sending the XOR-ed packet includes sending the XOR-ed packet to the wireless nodes in response to receiving the clear to send messages, the XOR-ed packet being generated by XORing at least two packets stored in an output queue of the relay node.

7. The method of claim 1 further comprising:
determining a set of native packets for each of the wireless nodes,
wherein the sending the XOR-ed packet includes sending the XOR-ed packet to the wireless nodes in response to receiving the clear to send messages, the XOR-ed packet being generated by XORing at least two queued packets stored in an output queue of the relay node, the at least two queued packets being selected based at least in part on the determined sets of native packets.

8. The method of claim 1 further comprising:
storing queued packets in an output queue;
storing nexthops for each of the queued packets; and
determining a set of native packets for each of the wireless nodes,
wherein the sending the XOR-ed packet includes sending the XOR-ed packet to the wireless nodes in response to receiving the clear to send messages, the XOR-ed packet being generated by XORing at least two of the queued packets stored, the at least two queued packets being selected based at least in part on the stored nexthops and the determined sets of native packets.

9. The method of claim 1, wherein:
the sending the XOR-ed packet to the wireless nodes includes sending the XOR-ed packet to the wireless nodes in response to receiving the clear to send messages, the XOR-ed packet indicating access channels for each of the wireless nodes to send acknowledgment messages; and
the method further comprises receiving, via the indicated access channels for sending the acknowledgment messages, the acknowledgment messages from each of the wireless nodes.

10. The method of claim 1, wherein:
the sending the XOR-ed packet to the wireless nodes includes sending the XOR-ed packet to the wireless nodes in response to receiving the clear to send messages, the XOR-ed packet indicating access channels for each of the wireless nodes to send acknowledgment messages;
the method further comprises receiving, via the indicated access channels for sending the acknowledgment messages, the acknowledgment messages from each of the wireless nodes; and
the method further comprises removing at least two queued packets from an output queue in response to receiving the acknowledgment messages.

11. The method claim 1 further comprising:
receiving a data packet from each of the wireless nodes,
wherein the sending the XOR-ed packet includes sending an XOR-ed packet to the wireless nodes, the XOR-ed packet being based on XOR-ing the received data packets together.

12. A method comprising:
receiving, by a wireless node in a wireless network, a ready to send message from a relay node, the ready to send message indicating an access channel to send a clear to send message;
sending, to the relay node, the clear to send message via the access channel indicated for the clear to send message;
receiving an XOR-ed packet from the relay node; and
decoding the XOR-ed packet by XOR-ing the XOR-ed packet with a native packet stored in a packet pool of the wireless node.

13. The method of claim 12 wherein:
the receiving the ready to send message includes receiving the ready to send message, the ready to send message indicating a time slot to send the clear to send message, and
the sending the clear to send message includes sending the clear to send message during the indicated time slot.

14. The method of claim 12, wherein the decoding includes decoding the XOR-ed packet by XOR-ing the XOR-ed packet with the native packet stored in the packet pool of the wireless nodes, the native packet having been previously transmitted by the wireless node.

15. The method of claim 12, wherein the deciding includes decoding the XOR-ed packet by XOR-ing the XOR-ed packet with the native packet stored in the packet pool of the wireless nodes, the native packet having been previously received by the wireless node from a neighboring wireless node.

16. An apparatus comprising:
a memory configured to store:
queued packets in an output queue; and
a packet pool for each of a plurality of wireless nodes;
a controller configured to:
select at least two of the queued packets based on the sets of native packets; and
generate an XOR-ed packet by XOR-ing at least two of the selected queued packets; and
a wireless transceiver configured to:
send a ready to send message to a plurality of wireless nodes, the ready to send message indicating access channels for each of the wireless nodes to send clear to send messages;
receive, via the indicated access channels for sending the clear to send messages, the clear to send messages from each of the wireless nodes; and
send the XOR-ed packet to the wireless nodes in response to receiving the clear to send messages.

17. The apparatus of claim 16, wherein the controller is further configured to add native packets to the packet pools based on receiving packets from the wireless nodes.

18. The apparatus of claim 16, wherein the controller is further configured to add native packets to the packet pools based on packet pool fields included in the clear to send messages.

19. An apparatus comprising:
a memory configured to store native packets in a packet pool;
a wireless transceiver configured to:
receive a ready to send message from a relay node, the ready to send message indicating an access channel to send a clear to send message;
send the clear to send message to the relay node via the access channel indicated for the clear to send message; and
receive an XOR-ed packet from the relay node; and
a controller configured to decode the XOR-ed packet by XOR-ing the XOR-ed packet with at least one of the native packets stored in the packet pool.

20. The apparatus of claim 19, wherein the wireless transceiver is configured to send the clear to send message to the relay node during a time slot indicated by the ready to send message.

21. The apparatus of claim 19, wherein:
the wireless transceiver is configured to send a packet to the relay node; and
the controller is configured to add the packet to the packet pool as a native packet based on the wireless transceiver sending the packet.

22. The apparatus of claim 19, wherein:
the wireless transceiver is configured to receive a packet from a neighboring wireless node; and
the controller is configured to add the packet to the packet pool as a native packet based on the wireless transceiver receiving the packet.
